(19) United States
(12) Patent Application Publication
(10) Pub. No.: US 2015/0321258 A1
(43) Pub. Date: Nov. 12, 2015

(54) DEVICE AND METHOD FOR PARTING OFF A PIPE

(71) Applicant: SANDVIK MATERIALS TECHNOLOGY DEUTSCHLAND GMBH, Düsseldorf (DE)

(72) Inventor: Thomas FROBOSE, Versmold (DE)

(21) Appl. No.: 14/651,512

(22) PCT Filed: Dec. 10, 2013
(86) PCT No.: PCT/EP2013/076097

§ 371 Date: Jun. 11, 2015

(30) Foreign Application Priority Data
Dec. 12, 2012 (DE) 10 2012 112 189.3

(51) Int. Cl. B23B 5/14; B23B 5/08; B23B 5/16; B23B 3/26

(52) U.S. Cl. CPC B23B 5/14; B23B 3/26; B23B 5/08; B23B 5/16

(57) ABSTRACT

A method for parting off and planing a pipe and a processing machine for parting off a pipe and for planing its end faces includes a first clamping device for a pipe to be machined, a second clamping device for the pipe to be machined, a tool holder for receiving a parting off tool, and a tool holder for receiving a planing tool, wherein the first and the second tool holders can rotate driven by a motor about an axis of rotation. At least the first or the second clamping device can be driven by a motor in a direction parallel to the axis of rotation of the first and of the second tool holder, wherein at least the first tool holder can be advanced/driven by a motor in a direction perpendicular to the axis of rotation.

The invention relates to a processing machine for parting off a pipe and for planing its end faces as well as to a method for parting off and planing a pipe.

In the manufacture of pipes, particularly by rolling and drawing, the finished pipes have to be cut to length at some point in time. This cutting to length of pipes is generally referred to as parting off. When parting off a pipe, said pipe is divided into two pipe sections.

For many applications it is necessary for the end faces of each finished cut-to-length pipe section to have a high surface precision and planeness. Particular specifications for the surface property, in particular the planeness, of the end faces of a pipe are set up for pipe sections that are to be connected to one another at a later time by orbital welding.

After the completion of the rolling or drawing, i.e., after the reduction of the inner and/or outer diameter to the required nominal size, the pipes are parted off outside of the rolling installation first in a first machine, and then their end or ending surfaces are machine finished.

The known methods are found to be disadvantageous in that they require a number of separate work steps after the removal of the finished pipe from the rolling mill.

In contrast, the aim of the present invention is to provide a processing machine and a method which make it possible to cut a finished pipe to length and machine finish it economically.

This aim is achieved according to the invention with a processing machine for parting off a pipe and for planing its end faces, having a first clamping device for a pipe to be machined, a second clamping device for the pipe to be machined, a tool holder for receiving a parting off tool, and a tool holder for receiving a planing tool, wherein the first and the second tool holders can rotate driven by a motor about an axis of rotation, wherein at least the first or the second clamping device can be moved driven by a motor in a direction parallel to the axis of rotation of the first and of the second tool holder, wherein at least the first tool holder can be advanced driven by a motor in a direction perpendicular to the axis of rotation, and wherein the first and the second tool holder are set up in such a manner that the tools that can be received in the tool holders can be made to engage between the first and the second clamping device with the pipe to be machined.

A processing machine of such a design makes it possible to carry out the parting off of a pipe and the planing of its end face in an economic manner in a single machine, wherein said machine in an embodiment can be integrated in a rolling mill or a drawing mill.

It is understood that the axis of rotation of the first and second tool holders is one and the same axis of rotation, which, during the operation of the machine, preferably coincides with the axis of symmetry of the pipe to be machined. For this purpose, the clamping devices in particular are arranged in such a manner that they clamp in the pipe to be machined, so that their axis of symmetry coincides with the axis of rotation of the tool holder.

When the expression “directions parallel or perpendicular to the axis of rotation” is used in the present application, it is understood that this is equivalent to directions perpendicular or parallel to the axis of symmetry of the pipe to be machined. Moreover, it is understood that when, in the sense of the present application, the expression “directions perpendicular or parallel to the axis of rotation” is used, slight deviations from parallel or vertical are possible, within the scope of the tolerances required for machining the pipe.

To be able to better understand the functionality of the processing machine according to the invention as well as its optional characteristics, said machine is explained in reference to the method according to the invention which can be carried out using the processing machine.

Indeed, the above-mentioned aim is achieved by a method for parting off a pipe and for planing its end faces which comprises the steps: clamping in a first pipe section of a pipe with a first clamping device, clamping in a second pipe section of a pipe with a second clamping device, rotating a parting off tool about an axis of rotation coinciding with an axis of symmetry of the pipe to be machined, advancing the parting off tool between the first and the second clamping device in a direction perpendicular to the axis of symmetry toward the pipe, engaging the parting off tool with the pipe and parting off the pipe, so that a first and a second pipe section are formed, moving the first and the second pipe section of the parted off pipe apart from each other, rotating a planing tool about the axis of rotation, moving the first pipe section and the planing tool relative to one another in a direction parallel to the axis of rotation toward each other, engaging the planing tool with an end face of the first pipe section and planing the end face of the first pipe section, moving the second pipe section and the planing tool relative to one another in a direction parallel to the axis of rotation toward each other, and engaging the planing tool with an end face of the second pipe section and planing the end face of the second pipe section.

Here, it is irrelevant for the present invention whether a planing of the end face of the first pipe section or a planing of the end face of the second pipe section occurs first.

The clamping in of the first and of the second pipe section of the pipe to be machined with in each case a first or second clamping device serves, during the machining, to lock in position first the entire pipe and then the first and second pipe sections that have been separated from each other. Since at least one of the first and second clamping devices is driven by a motor and can be moved in a direction parallel to the axis of rotation, the clamping devices make it possible to move the pipe ends of the first and second pipe sections apart from each other after the completion of the parting off of the pipe, to make room for the subsequent machine finishing of the end faces of the first and of the second pipe section.

Moreover, in an embodiment, a motor-driven clamping device makes it possible to produce a relative advancing movement of the pipe to be machined and of the facing tool in an axial direction, i.e., parallel to the rotation axis of the tool holder, without the tool holder itself having to advance in the axial direction.

If the two clamping devices provide the possibility for a motor driven movement parallel to the axis of rotation of the tool holders, then the relative advance movements can be carried out between the first pipe section received in the first clamping device and the planing tool, as well as between the second pipe section received in the second clamping device and the planing tool.

Additionally or alternatively to a motor drive of the two clamping devices in a direction parallel to the axis of rotation, the second tool holder can also comprise, for receiving the planing tool, a drive for a linear movement in a direction parallel to the axis of rotation.

Thus, if, in accordance with the present application, the expression “advancing the tool in a direction parallel to the axis of rotation toward the end face of the pipe section” is used, then this advance can be achieved either by the motor drive of the second tool holder parallel to the axis of rotation or by moving the pipe section to be machined parallel to the axis of rotation.

During the operation of the processing machine, the parting off tool received on the first tool holder is rotated about the axis of rotation and at the same time it is advanced in a direction perpendicular with respect to the axis of rotation, i.e., in a radial direction, toward the pipe to be parted off. As a result of this type of cutting in two, two mutually independent pipe sections are obtained, of which a first is clamped in the first clamping device and a second in the second clamping device.

After the parting off, by changing the distance between the two clamping devices, the two pipe sections are pulled apart, so that sufficient space is opened up between their end faces for the introduction of the planing tool.

In order to plane the end faces of the two pipe sections, the planing tool is rotated about the axis of rotation and at the same time it is advanced in a direction parallel to the axis of rotation onto the end face as desired either of the first or the second pipe section, or, on the other hand, it is advanced simultaneously onto the end faces of the first and second pipe sections. In the process, the planing tool engages with the end face, and the end face of the pipe section is planed. In the end, the planning is repeated for the end face of the other pipe section.

It is understood that a simultaneous planing of the end faces of the first and of the second pipe section is achieved preferably in that the relative positions of the first and of the second pipe section relative to the planing tool is varied by a simultaneous advance movement of the two clamping devices. In such an embodiment, the tool holders can be stationary in a direction parallel to their axis of rotation.

In an embodiment of the invention, the first tool holder and the second tool holder are set up rotatably about the axis of rotation in such a manner that they rotate at the same angular speed and are a constant distance from one another in the peripheral direction. In such an embodiment, it is possible that for the rotation movement of the first and of the second tool holder to be achieved by a single common drive.

In an additional embodiment of the invention, the first tool holder and the second tool holder can be advanced with the same advance speed in a direction perpendicular to the axis of rotation. Such an embodiment can also be implemented advantageously with a single common drive for the advance movement of the two tool holders.

In particular, the two tool holders can be received on a single machine element or base support, wherein they are separated from one another in the peripheral direction by an angle of at least 90° and preferably of approximately 180°.

If the first tool holder and the second tool holder are driven in each case by a common drive in the direction of rotation and optionally in the direction of advance, and if the first tool holder is connected to a parting off tool and the second tool holder is connected to a planing tool, then it is advantageous if the first tool holder with the parting off tool and the second tool holder with the planing tool, measured in a direction perpendicular to the axis of rotation, are arranged in such a manner that at the time of the advance of the tool holder onto the pipe to be machined, first the parting off tool and only thereafter the planing tool engages with the pipe to be machined.

This arrangement follows the logic that a planing of the end faces of the two parted off, i.e., mutually separated, pipe sections can occur only after the parting off.

In addition to the planing of the end faces, the planing tool which can be received on the second tool holder can be used for the chamfering of the end faces of at least one pipe section. For this purpose, the radial distance of the tools received in the tool holders, from the axis of rotation, is preferably selected in such a manner that the planing tool engages with the two pipe sections, while the parting off tool engages with the pipe or with the two pipe sections.

In an embodiment of the invention, a parting off tool is received in the first tool holder.

A parting off tool in the sense of the present application is, for example, a cutting plate or a cutting insert for machining with a defined cutting edge. A rotating cutting tool is particularly well suited as parting off tool.

In an embodiment of the invention, a planing tool is received in the second tool holder.

In an embodiment of the invention, the planing tool is a cutting plate or a cutting insert, preferably an indexable cutting plate, for machining with a defined cutting edge.

In an embodiment, the planing tool has an upper and a lower surface, and side surfaces extending between the upper and the lower surfaces. Here, the lower surface is used as application surface and, in the built-in state, it engages with a corresponding surface of the tool holder. Two facing edges in each case between a side surface and the upper surface form the cutting edges of such a cutting tool. The tool is received on the tool holder in such a manner that, at the time of the engagement of the planing tool with the workpiece, the upper surface forms the cutting surface of the tool. In an embodiment, the upper surface or the cutting surface has a concave curvature.

In an embodiment of invention, the processing machine comprises a cooling device with at least one nozzle for liquid CO₂, wherein the nozzle is arranged in such a manner that liquid CO₂ cools and lubricates the pipe to be machined, in the vicinity of the engagement between pipe and tool, during the operation of the device. It is understood that the cooling device also comprises or can also comprise, in addition to the nozzle, a corresponding line arrangement and a supply of liquid CO₂ as well as the corresponding associated regulating devices.

It is surprising that the cooling with CO₂ also achieves a lubrication between the tools and the workpiece, i.e., the pipe or the pipe sections, which leads to an optimized surface quality of the end faces of the pipe sections. Therefore, in an embodiment, it is not necessary to supply an additional lubricant besides the CO₂.

In an embodiment of the invention, the second tool holder is connected to a planing tool with a first and a second cutting edge, wherein the second tool holder and the planing tool are arranged in such a manner that the first cutting edge can engage with an end face of the first pipe section of the parted off tube, and the second cutting edge can engage with an end face of a second pipe section of the parted off pipe.

In this manner, using the same planing tool received in one and the same second tool holder, the ends of the mutually opposite end faces of the parted off pipe can be machine finished. Advantageously, this machine finishing of the two end faces can occur simultaneously here.

In an embodiment of the invention, the processing machine in addition comprises a control unit, wherein the control unit is arranged in such a manner that it controls the operation of the processing machine so that the latter performs the following steps: rotating the first and the second tool holder about the axis of rotation, advancing at least the first tool holder in a direction perpendicular to the axis of rotation, and during the rotation, for the purpose of parting off the pipe, moving at least the first and the second clamping device in a direction parallel to the axis of rotation, so that the distance between the first and the second clamping device is increased, producing a relative movement between at least the second tool holder relative to the first clamping device in a first direction parallel to the axis of rotation for planing an end face of a first pipe section of the parted off pipe, and producing a relative movement between at least the second tool holder relative to the second clamping device in a second direction opposite the first direction for planing an end face of a second pipe section of the parted off pipe.

In summary, the control unit is thus arranged in such a manner that it controls the processing machine during operation in such a manner that it carries out the method according to the invention.

Here, the control unit is advantageously arranged, in an embodiment, in such a manner that it simultaneously produces the relative movements of the second tool holder relative to the first and second clamping devices, so that the two end faces of the two pipe sections are planed simultaneously.

In an embodiment, the control unit moreover is arranged in such a manner that, during operation, it controls the processing machine so that the latter additionally performs the following steps: during the advance of the first tool holder in a direction perpendicular to the axis of rotation, advancing the second tool holder in the same direction and simultaneously engaging the parting off tool received by the first tool holder and the planing tool received on the second tool holder with the pipe to be parted off.

Additional advantages, features and application possibilities of the present invention will become clear in reference to the following description of an embodiment and of the associated figures.

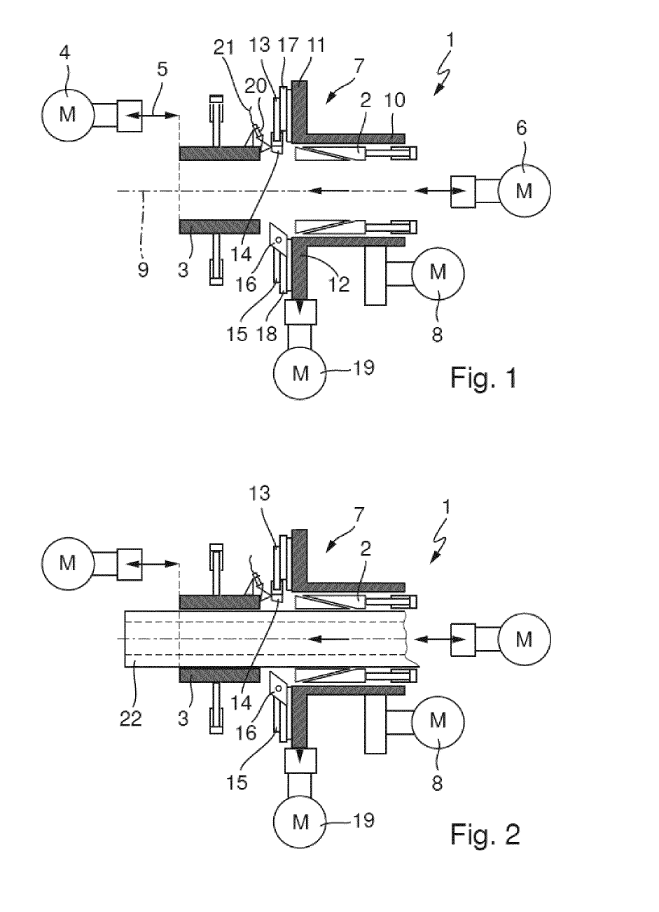

FIG. 1 shows a diagrammatic side view of a processing machine according to the invention.

FIG. 2 shows a diagrammatic side view of the processing machine of FIG. 1 with a pipe clamped therein.

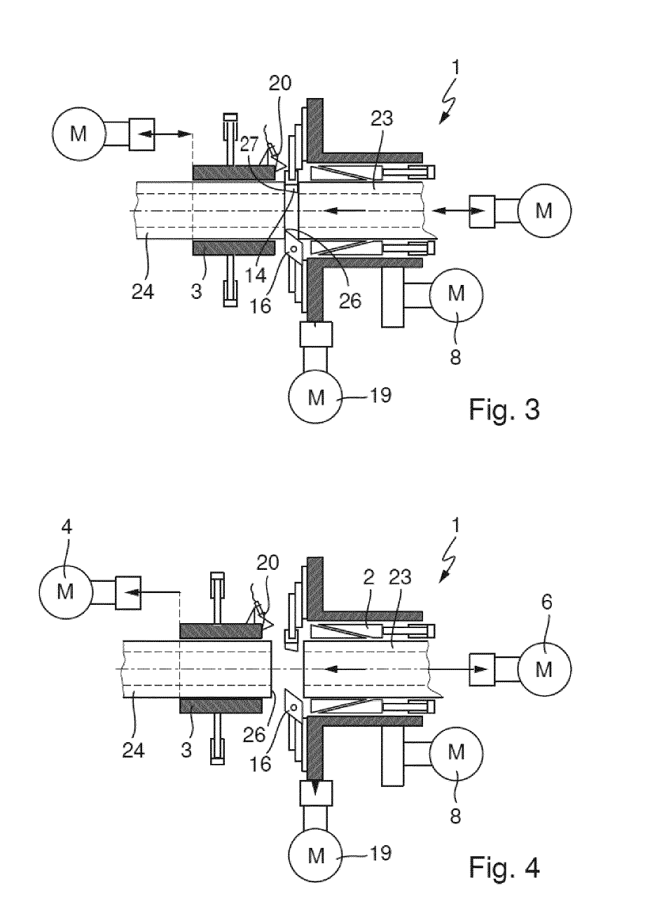

FIG. 3 shows a diagrammatic side view of the processing machine of FIGS. 1 and 2 during the parting off.

FIG. 4 shows a diagrammatic side view of the processing machine of FIGS. 1 to 3 as the pipe sections are moved apart.

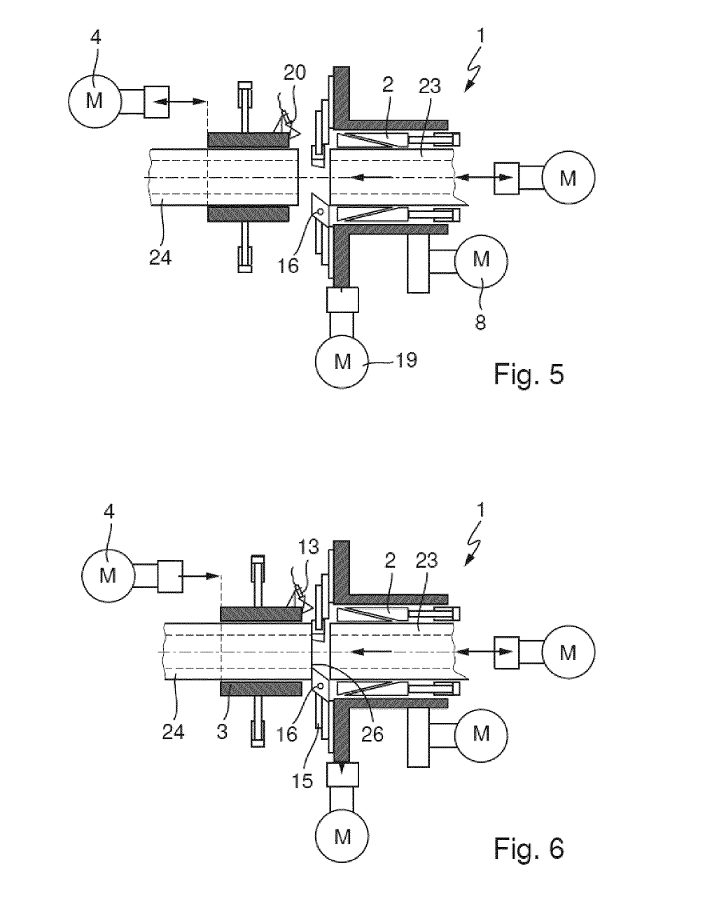

FIG. 5 shows a diagrammatic side view of the processing machine of FIGS. 1 to 4 at the time of the insertion of the planing tool.

FIG. 6 shows a diagrammatic side view of the processing machine of FIGS. 1 to 5 during the planing of the end face of a pipe section.

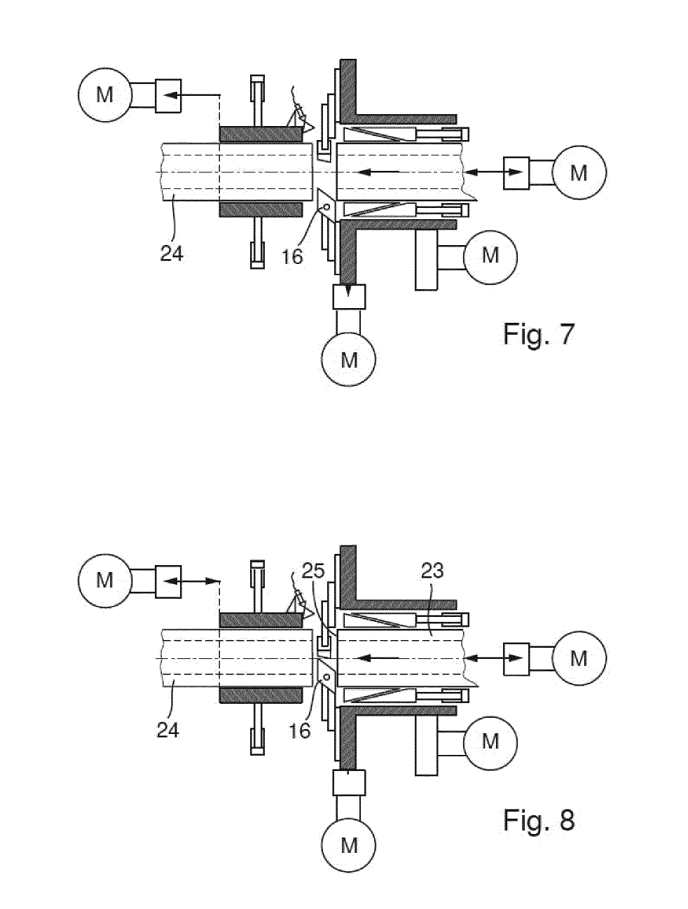

FIG. 7 shows a diagrammatic side view of the processing machine of FIGS. 1 to 6 after the completion of the planing of the end face of the first pipe section.

FIG. 8 shows a diagrammatic side view of the processing machine of FIGS. 1 to 7 at the time of the transition to the machining of the end face of a second pipe section.

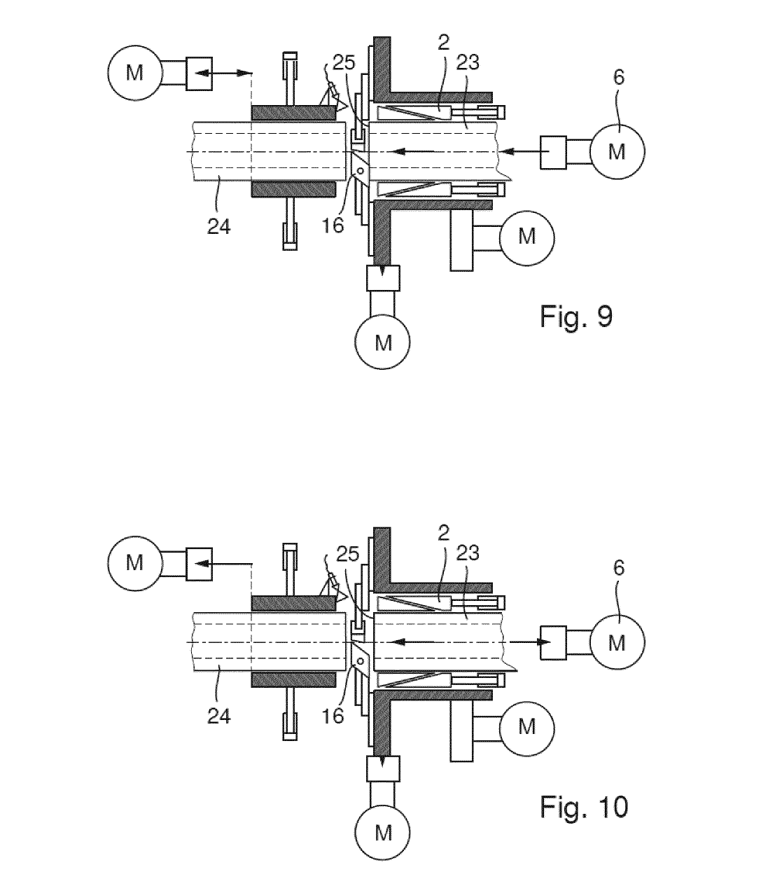

FIG. 9 shows a diagrammatic side view of the processing machine of FIGS. 1 to 8 at the time of the planing of the end face of the second pipe section.

FIG. 10 shows a diagrammatic side view of the processing machine of FIGS. 1 to 9 after the completion of the machining of an end face of the second pipe section.

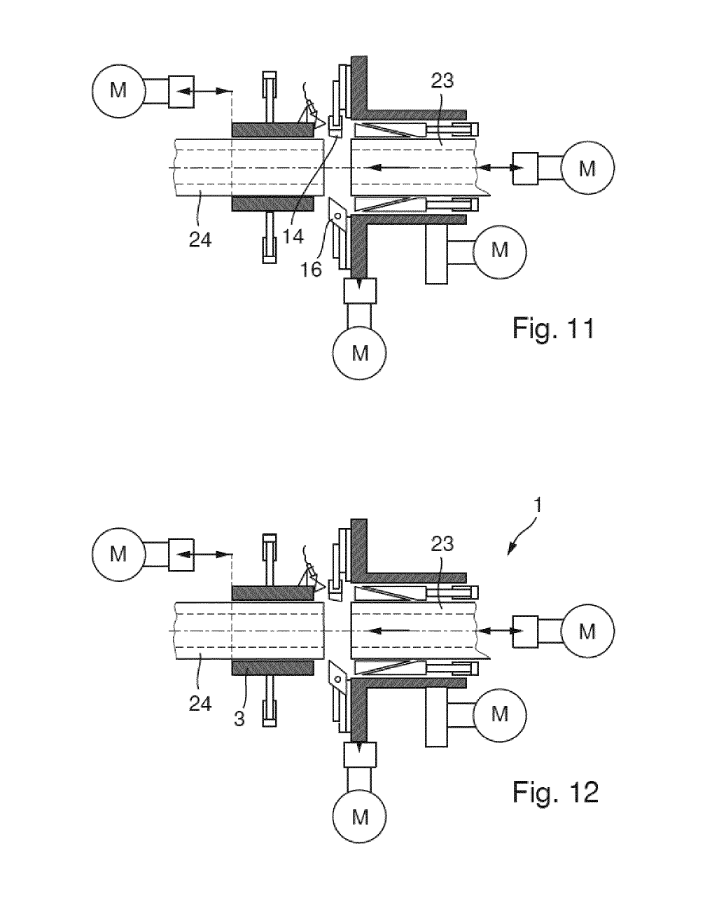

FIG. 11 shows a diagrammatic side view of the processing machine of FIGS. 1 to 10 after the withdrawal of the tools.

FIG. 12 shows a diagrammatic side view of the processing machine of FIGS. 1 to 11 after the unclamping of the pipe sections.

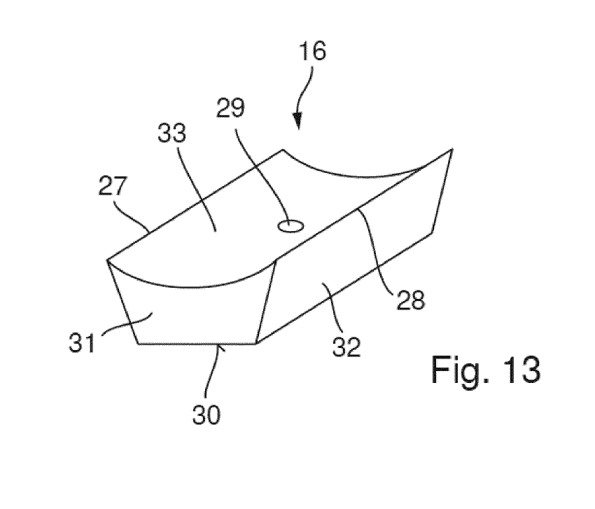

FIG. 13 shows a perspective representation of an embodiment of the planing tool.

In the figures, identical reference numerals mark identical elements.

FIG. 1 shows a diagrammatic side view of an embodiment of the processing machine 1 according to the invention for parting off a pipe as well as for planing the end faces of the separated pipe sections which are produced as a result of the parting off.

In the represented embodiment, the processing machine 1 comprises a clamping cylinder 2 as well as a take-off device 3, which are used as the first and second clamping devices for a pipe to be machined in the machine 1. Both the take-off device 3 can be moved by means of a motor 4 in a direction 5 parallel to the axis of rotation 9 of the tool holders, and the clamping cylinder 2 can also be moved by means of a drive 6 in a direction 5 parallel to the axis of rotation 9. Moreover, the processing machine 1 is arranged so it can be rotated by a motor drive 8 by means of a base support 7 about the axis of rotation 9.

The base support 7 consists substantially of a cylindrical sleeve 10 and of two arms 11, 12 protruding substantially perpendicularly to the axis of rotation 9, i.e., in a radial direction, from the sleeve 10. The arms 11, 12 are separated by 180° from each other in the peripheral direction, i.e., they are arranged on opposite sides of the sleeve 10. Each one of the arms 11, 12 carries a tool holder.

Here, the tool holder 13 attached to the arm 11 is referred to below as the first tool holder. The parting off tool 14 itself is connected exchangeably to said tool holder. In the sense of the present application, the second tool holder 15, with the planing tool 16 received thereon, is arranged on the second arm 12. The two tool holders 13, 15 are connected via linear guides 17, 18 to the arms 11 or 12. In this manner, the tool holders 13, 15 or the tools 14, 16 connected to them can be advanced in a radial direction, i.e., in a direction perpendicular to the axis of rotation 9, onto a pipe which can be received in the clamping devices 2, 3.

In the represented embodiment, the two linear adjusters 17, 18 are driven by the same motor 19 via an appropriate gear box.

The concrete embodiment of the processing machine according to the invention shown here thus allows the two tools 14, 16 to rotate at the same angular speed and with a constant separation from each other in the peripheral direction, since the two rotation movements are produced by the same motor 8. In addition, the two tools 14, 16 are advanced simultaneously and at the same speed of advance onto the tube. Only the difference in the distance of the two tools 14, 16 from the axis of rotation 9 determines which of the two tools 14, 16 engages with the workpiece, i.e., the pipe, at what time.

The machining device according to the invention in addition comprises a nozzle 20 which is connected via a supply line 21 to a CO₂ reserve, so that the workpiece can be cooled in the engagement area during the machining. The liquid CO₂ used for the cooling is also used for the lubrication between the workpiece, i.e., the pipe, and the tools, and it considerably improves the surface quality particularly of the end faces of the two separated pipe sections.

The functioning and the operation of the machining device 1 according to the invention is now described in reference to FIGS. 2 to 12 which show a complete parting off and planing process according to the present invention. FIGS. 2 to 12 here show temporally successive instantaneous views of the machining device according to the invention during operation.

Here, for a better overview, only those elements of the device 1 that are needed for the description of the respective process step are provided with reference numerals in FIGS. 2 to 12.

In FIG. 2, a pipe 22 to be parted off is received in the machining device 1. Said pipe is received and clamped in the take-off device 3 and also in the clamping cylinder 2. The two tool holders 13, 15 with the tools 14 and 16 received therein rotate, driven by the drive motor 8, at constant angular speed around the pipe 22 or its axis of symmetry which coincides with the axis of rotation 9.

By advancing the two tools 14, 16 in a radial direction, i.e., toward the axis of rotation 9, first the parting off tool 14, as represented in FIG. 3, engages with the pipe, and the parting off tool 14 cuts the pipe 22 in two, so that said pipe is divided into a first pipe section 23 and a second pipe section 24.

While the parting off tool 14 is still engaged with the pipe or its sections 23, 24, the planing tool 16 already engages with them and takes hold of them.

During the entire parting off process, but also during the later planing of the end faces 25 or 26 of the first 23 or of the second 24 pipe section, end faces which are produced by parting off the pipe, CO₂ flows through the nozzle 20 onto the pipe 22, 23, 24 in the parting off area. After the completion of the parting off, i.e., cutting the pipe 22 in two, the two pipe sections 23, 24 produced by parting off, as represented in FIG. 4, are abruptly moved apart from each other or opened out. This opening out occurs by moving the clamping devices 2, 3 by means of their motor drives 6, 4 in opposite directions. As a result, the distance between the end faces 25, 26 increases, so that the planing tool 16 can be inserted into the gap between the two pipe sections 23, 24.

The insertion of the planing tool 16 into the gap between the pipe sections 23 and 24 occurs by an additional advance of the planing tool in a radial direction by the motor drive 19. The insertion of the planing tool into the gap between the pipe sections 23 and 24 is shown in FIG. 5.

Subsequently, the end faces 26, 27 of the pipe sections 23 and 24 are then planed. This final machining can be seen in FIGS. 6 to 11.

Since the tool holders 13, 15 do not comprise a linear drive for an advance movement in a direction parallel to their axis of rotation or to the axis of symmetry of the pipe, the required advance movement of the planing tool 16 relative to the pipe sections 23 or 24 is produced by an active motor-driven moving of the clamping units 2, 3, wherein the end faces of the pipe sections 23, 24 are moved toward the planing tool 16, until the latter engages with the end faces and until the respective machining of the ends is completed.

FIG. 6 shows the machining of the end face of the second pipe section 24, wherein the take-off device 3 is moved onto the planing tool 16, driven by the motor 4, so that the planning tool engages with the end face 26 of the second pipe section 24, and planes this end face. After the machining of the ends of the second pipe section 24 has been completed, said section is again withdrawn from the planing tool 16, as shown in FIG. 7.

In the represented embodiment, the planing tool 16 is a rhombic indexable cutting plate with cutting edges on two sides of the indexable cutting plate. Since the cutting edges of the indexable cutting plate are arranged in a radial direction, i.e., in a direction perpendicular to the axis of rotation of the tool with mutual shift, it is necessary, after the machining of the end face 26 of the second pipe section 24, to advance the planing tool 16 again in the direction toward the axis of rotation, so that the second cutting edge can engage with the end face 27 of the first pipe section 23. The state after renewed advance of the planing tool 16 in a radial direction is shown in FIG. 8.

In a following step, the first pipe section 23 clamped into the first clamping device 2 is then advanced by means of the drive 6 onto the planing tool 16, so that the latter engages with the end face 27 of the first pipe section 23 and planes said end face. The planing of the end face of the first pipe section 23 is shown in FIG. 9.

After the planing of the end face of the first pipe section 23 has been completed, the two pipe sections 23, 24 are moved apart again (see FIG. 10), so that there is space to for removing the tools 14, 16, as shown in FIG. 11, from the gap between the two pipe sections 23, 24.

Finally, as shown in FIG. 12, the two pipe sections 23, 24 are unclamped, wherein the second pipe section 24 with the take-off device 3 is removed from the device 1, while the first pipe section 23 is moved through the device, so that then, after measuring a selected length, the pipe 23 can be parted off again.

Alternatively to the representation of FIGS. 6 and 9, the planing of the end faces 25, 26 of the two pipe sections 23, 24 can also occur simultaneously, wherein the two clamping devices for the two pipe sections 23, 24 can be advanced simultaneously onto the second tool holder 15.

In FIG. 13, an embodiment of a planing tool 16 which can be received in the second tool holder 15 is represented. The planing tool 16 is an indexable cutting insert with two cutting edges 27, 28 for cutting the pipe ends of two pipe sections. During operation, the cutting insert 16 is received in such a manner on the second tool holder that the first cutting edge 27 can machine the pipe end of a first pipe section which has been parted off prior to this, and the second cutting edge 28 can machine a second pipe section of a pipe which has been parted off prior to this. The tool 16 has a central attachment hole 29 for receiving the cutting insert 16 on the second tool holder. The cutting insert furthermore has a lower surface or bottom surface 30, which is used as an application surface on the second tool holder 15, and side surfaces 31, 32 which connect the lower surface 30 to an upper surface 33. The upper surface 33 has a concave design in the represented embodiment. The cutting insert 16 can be received on the second tool holder in such a manner that, during the machining of the pipe ends, the upper surface 33 is used as surface for chips on which the chips run off.

For the purpose of the original disclosure, it is pointed out that all the features, as they are apparent to a person skilled in the art from the present description, the drawings and the claims, even if they have been described in concrete terms only in connection with certain additional features, can be combined either individually and also in any combinations with other features or groups of features disclosed here, provided that such combinations are not exclusively ruled out or or rendered impossible or senseless by technical conditions. It is only for the sake of brevity and readability of the description that a comprehensive, explicit representation of all the conceivable combinations of features is dispensed with here.

While the invention has been represented and described in detail in the drawings and the previous description, this representation and description are considered merely to be examples and not a limitation of the scope of protection as defined by the claims. The invention is not limited to the disclosed embodiments.

Deviations from the disclosed embodiments are evident to the person skilled in the art from the drawings, the description and the attached claims. In the claims the word “comprise” does not exclude other elements or steps, and the indefinite article “a” or “an” does not rule out a plurality. The mere fact that certain features are claimed in different claims does not rule out their combination. Reference numerals in the claims are not intended to be a limitation of the scope of protection.

### LIST OF REFERENCE NUMERALS

1 Processing machine

2 Clamping cylinder

3 Take-off device

4, 6, 8, 19 Motor

5 Direction parallel to the axis of rotation

7 Base support

9 Axis of rotation

10 Cylindrical sleeve

11, 12 Arm

13 First tool holder

14 Parting off tool

15 Second tool holder

16 Planing tool

17, 18 Linear guide/adjusters

20 Nozzle

21 Supply line

22 Pipe

23 First pipe section

24 Second pipe section

25, 26 End faces

27, 28 Cutting edges

29 Attachment hole

30 Bottom surface

31, 32 Side surfaces

33 Cutting surface

1. A processing machine for parting off a pipe and for planing its end faces comprising:
a first clamping device for a pipe to be machined;
a second clamping device for the pipe to be machined;
a first tool holder for receiving a parting off tool; and
a second tool holder for receiving a planing tool, wherein the first tool holder and the second tool holder are driven by a motor and can be rotated about an axis of rotation, at least the first or the second clamping device being driven by a motor in a direction parallel to the axis of rotation of the first tool holder and second tool holder, at least the first tool holder being driven by a motor in a direction perpendicular to the axis of rotation, and wherein the first tool holder and the second tool holder are arranged in such a manner that the tools received in the tool holders are engaged, between the first clamping device and the second clamping device, with the pipe to be machined.

2. Processing A processing machine according to claim 1, wherein the first tool holder and the second tool holder are driven by a common drive, and arranged rotatably about the axis of rotation such that they rotate at the same angular speed and have a constant separation from one another in a peripheral direction.

3. A processing machine according to claim 1, wherein the first tool holder and the second tool holder are driven by a common drive, and advanced at a same speed of advance in a direction perpendicular to the axis of rotation.

4. A processing machine according to claim 1, wherein the first tool holder and the second tool holder are separated by an angle of at least 90° and preferably of approximately 180° in a peripheral direction from one another.

5. A processing machine according to claim 1, wherein the first tool holder is connected to a parting off tool and the second tool holder is connected to a planing tool, wherein the first tool holder with the parting off tool and the second tool holder with the planing tool, measured in a direction perpendicular to the axis of rotation, are arranged such that at the time of the advance of the tool holder onto the pipe to be machined, first the parting off tool and only thereafter the planing tool engages with the pipe to be machined.

6. A processing machine claim 1, further comprising a cooling device with at least one nozzle for liquid CO₂, wherein the nozzle is arranged such that the liquid CO₂, during the operation of the device, cools the pipe to be machined in the vicinity of the engagement between pipe and tool.

7. A processing machine according to claim 1, wherein the second tool holder is connected to a planing tool with a first and a second cutting edge, wherein the second tool holder and the planing tool are arranged such that the first cutting edge engages with an end face of a first pipe section of the parted off pipe, and the second cutting edge can be made to engage with an end face of a second pipe section of the parted off pipe.

8. A processing machine according to claim 1, further comprising a control unit, wherein the control unit is arranged such that, during operation, it controls the processing machine so that the processing machine performs the following steps:
rotating the first tool holder and the second tool holder about the axis of rotation;
advancing at least the first tool holder in a direction perpendicular to the axis of rotation and during the rotation, for the purpose of parting off the pipe;
moving at least the first or the second clamping device in a direction parallel to the axis of rotation, so that the distance between the first and the second clamping device is increased;
producing a relative movement between at least the second tool holder relative to the first clamping device in a first direction parallel to the axis of rotation for planing an end face of a first pipe section of the parted off pipe; and
producing a relative movement between at least the second tool holder relative to the second clamping device in a second direction opposite the first direction for planing an end face of a second pipe section of the parted off pipe.

9. A processing machine according to claim 8, wherein the control unit is arranged such that, during operation, it controls the processing machine so that the processing machine additionally performs the following steps:
during the advance of the first tool holder in a direction perpendicular to the axis of rotation, advancing the second tool holder in the same direction, and engaging a planing tool received in the second tool holder with the pipe, for machining the pipe.

10. A method for parting off a pipe and for planing its end faces comprising the steps of:
clamping in a first pipe section of a pipe with a first clamping device;
clamping in a second pipe section of the pipe with a second clamping device;
rotating a parting off tool about an axis of rotation coinciding with an axis of symmetry of the pipe to be machined;
advancing the parting off tool between the first and the second clamping devices in a direction perpendicular to the axis of rotation onto the pipe;
engaging the parting off tool with the pipe and parting off the pipe, so that a first pipe section and a second pipe section are formed;
moving the first and the second pipe sections of the parted off pipe apart from each other;
rotating a planing tool about the axis of rotation;
moving the first pipe section and the planing tool relative to one another in a direction parallel to the axis of rotation toward each other;
engaging the planing tool with an end surface of the first pipe section and planing the end surface of the first pipe section;
moving the second pipe section and the planing tool relative to one another in a direction parallel to the axis of rotation toward each other; and
engaging the planing tool with an end face of the second pipe section and planing the end face of the second pipe section.
